(19) United States
(12) Patent Application Publication
(10) Pub. No.: US 2025/0024425 A1
(43) Pub. Date: Jan. 16, 2025

(54) ANNOTATION DEVICE, ANNOTATION METHOD, AND LEARNING DEVICE

(71) Applicant: MITSUBISHI ELECTRIC CORPORATION, Tokyo (JP)

(72) Inventors: Kenya SUGIHARA, Tokyo (JP); Ryoma YATAKA, Tokyo (JP); Kenichi OGAWA, Tokyo (JP); Masashi SHIRAISHI, Tokyo (JP); Kei SUWA, Tokyo (JP); Shinya TSURUTA, Tokyo (JP)

(73) Assignee: MITSUBISHI ELECTRIC CORPORATION, Tokyo (JP)

(21) Appl. No.: 18/897,050

(22) Filed: Sep. 26, 2024

Related U.S. Application Data
(63) Continuation of application No. PCT/JP2022/018792, filed on Apr. 26, 2022.

(51) Int. Cl. H04W 64/00; G01S 11/02; H04W 4/38

(52) U.S. Cl. CPC H04W 64/006; G01S 11/02; H04W 4/38

(57) ABSTRACT

An annotation device includes: a signal acquiring unit that acquires a signal indicating a detection result for a mobile object from a sensor; a display control unit that displays the signal acquired on a PPI display device as a signal in time series; a reception unit that receives an operation by a user on the signal displayed on the PPI display device and including an input indicating that the signal is a false signal or a true signal; a storage control unit that stores the operation in a storage unit as an operation log; and a calculation unit that calculates a probability that a signal indicating a false signal is a false signal or a probability that a signal indicating a true signal is a true signal as a continuous value changing depending on a content of an operation specified with the operation log.

### CROSS REFERENCE TO RELATED APPLICATION

This application is a Continuation of PCT International Application No. PCT/JP2022/018792, filed on Apr. 26, 2022, which is hereby expressly incorporated by reference into the present application.

### TECHNICAL FIELD

The present disclosure relates to an annotation device, an annotation method, and a learning device.

### BACKGROUND ART

An object of an information processing device of Patent Literature 1 common to an annotation device according to the present disclosure in terms of performing annotation for generating teacher data used for machine learning is to suppress deterioration in quality of teacher data. In order to achieve the object, the information processing device calculates accuracy of labeling a detection target object. More specifically, the information processing device receives, from a user, labeling including designation of a region of a detection target object included in image data and designation of a label for the detection target object. In addition, the information processing device specifies a work content of the user at the time of receiving the labeling. Then, the information processing device calculates reliability indicating accuracy of the labeling using the information of the specified work content. Note that, in Patent Literature 1, the detection target object to be labeled by the user is basically an object that is stationary in an image indicated by image data.

### CITATION LIST

### Patent Literature

Patent Literature 1: JP 2019-101559 A

### SUMMARY OF INVENTION

### Technical Problem

Meanwhile, there is a system in which signals indicated by one or more pieces of signal data acquired by a sensor (including a radar) are displayed on a display device over time, and a signal (hereinafter, also referred to as “false signal”) in which a user is not interested is determined and input among the signals. Examples of such a system include a radar system in which a user determines an unnecessary false signal, inputs the determination result, and deletes the false signal from a display in a plan position indicator (PPI) display device that displays a signal indicating an object such as a ship captured by a radar.

In this radar system, with respect to a track that is a time-series signal for which tracking is established by performing signal processing on a reception signal of a radar, a user determines whether or not the track indicates an object of interest. Then, when determining that the track is a track of no interest (that is, a false signal), the user performs an operation of deleting the track from a display screen. Note that the track deleted from the display screen is also excluded from a tracking target by signal processing. In contrast, the user can determine a signal of interest (hereinafter, also referred to as “true signal”) and leave only the true signal on the display screen.

In this radar system, since a false signal or a true signal is determined manually as described above, human cost is required. Therefore, in this system, there is a need to generate a machine learning model capable of accurately identifying a false signal or a true signal from among signals indicated by one or more pieces of signal data acquired by a sensor. Therefore, it is conceivable to apply the technique described in Patent Literature 1 in order to generate a machine learning model with high identification accuracy.

However, as described above, the technique described in Patent Literature 1 is basically based on the premise that a detection target object stationary in an image is labeled. Meanwhile, since a display state of a signal displayed on a PPI display device as described above changes in time series, a temporal element such as a time from when the signal is displayed to when the signal can be identified is desirably added to accuracy of identifying whether the signal is a false signal (or a true signal). Therefore, in this respect, it is difficult to apply the technique described in Patent Literature 1 to annotation for a signal whose display state changes in time series as described above.

An object of the present disclosure is to provide an annotation device capable of performing annotation for generating a machine learning model capable of accurately identifying a false signal or a true signal from a signal whose display state changes in time series and which is displayed on a PPI display device.

### Solution to Problem

An annotation device according to the present disclosure technology includes: a processor; and a memory storing a program, upon executed by the processor, to perform a process: to acquire a signal indicating a detection result for a mobile object moving with lapse of time from a sensor to detect the mobile object; to display the signal acquired on a plan position indicator (PPI) display device as a signal whose display state changes in time series; to receive an operation performed by a user on the signal displayed on the PPI display device and including an input indicating that the signal is a false signal or an input indicating that the signal is a true signal; to store the operation received in a storage as an operation log; and to calculate a probability that a signal for which the input indicating a false signal is received is a false signal or a probability that a signal for which the input indicating a true signal is received is a true signal as a continuous value changing depending on a content of an operation specified with the operation log stored in the storage, wherein the process acquires a plurality of the signals, the process displays each of the plurality of signals acquired on the PPI display device as a signal whose display state changes in time series, and wherein the process specifies, with the operation log, a time when the process displays the signal on the PPI display device and a time when the process receives an input indicating that the signal is a false signal or an input indicating that the signal is a true signal, calculates a probability that the signal for which the input indicating a false signal is received is a false signal or a probability that the signal for which the input indicating a true signal is received is a true signal as a continuous value changing depending on a time from the time when the signal is displayed on the PPI display device to the time when the process receives the input indicating that the signal is a false signal or the input indicating that the signal is a true signal, corrects a time when the input indicating that the signal is a false signal or the input indicating that the signal is a true signal is received on a basis of at least one of the number of signals displayed on the PPI display device by the process and a density of the signals in a predetermined range on a display screen of the PPI display device, and calculates a probability that the signal for which the input indicating a false signal is received is a false signal or a probability that the signal for which the input indicating a true signal is received is a true signal as a continuous value changing depending on a time from a time when the signal is displayed on the PPI display device to the corrected time.

### Advantageous Effects of Invention

According to the present disclosure, with the above-described configuration, it is possible to perform annotation for generating a machine learning model capable of accurately identifying a false signal or a true signal from a signal whose display state changes in time series and which is displayed on a PPI display device.

### BRIEF DESCRIPTION OF DRAWINGS

FIG. 1 is a configuration diagram illustrating a learning device including an annotation device according to a first embodiment.

FIG. 2 is a flowchart illustrating an operation example of the annotation device according to the first embodiment.

FIG. 3 is a diagram for describing a calculation example of a probability of a false signal by a probability calculating unit in the first embodiment.

FIG. 4 is a diagram illustrating an example in which the probability calculating unit in the first embodiment changes a maximum value of a probability of a false signal with respect to a determination time.

FIG. 5 is a diagram illustrating another calculation example of a probability of a false signal by the probability calculating unit in the first embodiment.

FIG. 6 is a diagram illustrating an example in which the probability calculating unit in the first embodiment changes a slope of a probability of a false signal with respect to a determination time.

FIG. 7 is a flowchart illustrating an operation example of the learning device according to the first embodiment.

FIGS. 8A and 8B are each a diagram illustrating an example of a hardware configuration of the annotation device in the first embodiment.

FIG. 9 is a configuration diagram illustrating a learning device including an annotation device according to a second embodiment.

FIG. 10 is a flowchart illustrating an operation example of the annotation device according to the second embodiment.

### DESCRIPTION OF EMBODIMENTS

Hereinafter, embodiments will be described in detail with reference to the drawings.

### First Embodiment

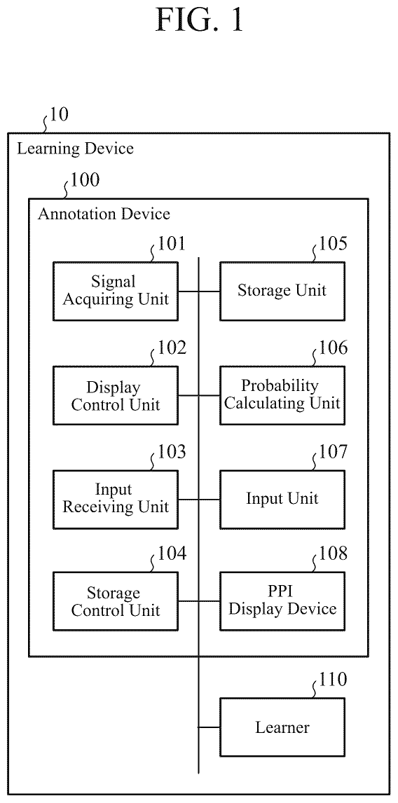

FIG. 1 is a configuration diagram illustrating a learning device 10 including an annotation device 100 according to a first embodiment. The annotation device 100 according to the first embodiment generates teacher data (annotation) for generating a machine learning model capable of identifying a false signal or a true signal from a signal displayed on a PPI display device. In addition, the learning device 10 according to the first embodiment generates a machine learning model capable of identifying a false signal or a true signal from a signal displayed on the PPI display device by performing machine learning using an output result by the annotation device 100 as teacher data.

### (Annotation Device 100)

The annotation device 100 includes a signal acquiring unit 101, a display control unit 102, an input receiving unit 103, a storage control unit 104, a storage unit 105, a probability calculating unit 106, an input unit 107, and a PPI display device 108. The input receiving unit 103 constitutes a reception unit described in claim 1. The probability calculating unit 106 constitutes a calculation unit described in claim 1. A sensor (not illustrated) is connected to the annotation device 100.

The sensor periodically detects a mobile object (for example, a ship) moving with lapse of time, and outputs a signal indicating the detected mobile object. The sensor also includes a radar.

The signal acquiring unit 101 acquires a signal output from the sensor. Note that, when acquiring a signal from the sensor, the signal acquiring unit 101 may suppress an unnecessary signal component from the acquired signal or may perform tracking processing of a mobile object indicated by the acquired signal. In addition, the signal acquiring unit 101 may perform predetermined signal processing and extract a predetermined feature amount (for example, an orientation and coordinates, a moving speed, and a signal strength of a mobile object indicated by the signal) from the acquired signal.

The display control unit 102 displays the signal acquired by the signal acquiring unit 101 on the PPI display device 108 as a signal whose display state changes in time series. As a result, a state in which the signal acquired by the signal acquiring unit 101 changes from moment to moment is displayed on the PPI display device 108.

Note that the display control unit 102 may display a waveform of the signal acquired by the signal acquiring unit 101 on the PPI display device 108. In addition, in a case where the above-described feature amount is extracted by the signal acquiring unit 101, the display control unit 102 may display the extracted feature amount on the PPI display device 108. In addition, the display control unit 102 may perform enlargement and reduction of a signal displayed on the PPI display device 108, control in a time direction, such as fast-forwarding reproduction and rewinding reproduction, and control such as screen scrolling in response to an operation by a user.

The input receiving unit 103 receives an operation performed by the user on a signal displayed on the PPI display device 108 and including an input indicating that the signal is a false signal or an input indicating that the signal is a true signal. Note that the operation includes various operations such as enlargement and reduction of a signal displayed on the PPI display device 108, fast-forwarding reproduction and rewinding reproduction, and screen scrolling in addition to the input indicating that the signal is the false signal or the input indicating that the signal is the true signal described above.

Specifically, the user looks at a signal, a feature amount, and the like displayed on the PPI display device 108 by the display control unit 102, and determines whether each signal is a false signal or a true signal while performing an operation such as enlargement of the signal as necessary. For example, when determining that a certain signal is a false signal, the user inputs that the signal is a false signal using the input unit 107. The input receiving unit 103 receives an operation and an input performed by the user.

Note that the display control unit 102 may delete, from the display screen of the PPI display device 108, a signal for which the input indicating a false signal is received by the input receiving unit 103, or may cause the signal to fade out from the display screen. In addition, the display control unit 102 may give a certain identifier (mark) to a signal for which the input indicating a false signal or a true signal is received by the input receiving unit 103 in such a manner that the user can easily recognize the signal.

The storage control unit 104 stores signal data indicating a signal acquired by the signal acquiring unit 101 and an operation log by the user in the storage unit 105.

The signal data includes, for example, information such as a signal ID and a time acquired by the signal acquiring unit 101. In addition, in a case where predetermined signal processing is performed on the acquired signal by the signal acquiring unit 101, the signal data includes data (for example, a feature amount) obtained by the signal processing. Note that, since the feature amount changes with lapse of time, for example, the feature amount is stored in time series in such a manner as to be related with a signal ID.

The operation log by the user (hereinafter, also simply referred to as “operation log”) is a log related to an input operation by the user when the input receiving unit 103 receives an input indicating that a certain signal is a false signal or a true signal from the user.

For example, the operation log includes a signal ID of a signal for which an input indicating a false signal or a true signal is received from the user, a time when the signal is displayed on the PPI display device 108 by the display control unit 102, a time when the input indicating a false signal or a true signal is received from the user for the signal, and information related to what kind of operation is performed by the user on the signal. Note that the information related to the operation from the user also includes information of a time when the user performs the operation.

The storage unit 105 is a storage medium in which the signal data and the operation log are stored by the storage control unit 104. The storage unit 105 is constituted by, for example, a hard disc drive (HDD), a solid state drive (SSD), or a random access memory (RAM).

The probability calculating unit 106 calculates a probability that a signal for which an input indicating a false signal is received by the input receiving unit 103 is a false signal (hereinafter, also referred to as “probability of a false signal”) or a probability that a signal for which an input indicating a true signal is received by the input receiving unit 103 is a true signal (hereinafter, also referred to as “probability of a true signal”) as a continuous value changing depending on a content of an operation specified with the operation log stored in the storage unit 105. For example, the probability calculating unit 106 specifies how long the user has performed an input with the operation log, and calculates the probability of a false signal or the probability of a true signal as a continuous value changing depending on the time.

For example, when a probability indicating whether or not a certain signal is a false signal is quantified, it is reasonable to consider that the value changes with time. In general, a user who determines a false signal by looking at a signal displayed on the PPI display device 108 determines that the signal is a false signal over a certain period of time by looking at a state of a change in display with lapse of time, and inputs the determination result.

Considering such a process in which the user determines a false signal, it is reasonable to consider that a signal immediately after being displayed on the PPI display device 108 has a feature that it is relatively difficult to determine whether the signal is true or false, and a feature for determining whether the signal is a false signal or a true signal becomes clear with lapse of time. Meanwhile, it is conceivable that there is a case where the user determines that the signal is a false signal immediately after the signal is displayed, but this can be interpreted as a case where a time in which a feature indicating that the signal is a false signal becomes clear is extremely short.

In any case, it is conceivable that there is a relationship between a time required for the user to make a determination and a change in feature of the signal. When learning such a relationship by machine learning is considered, there is preferably a significant relationship between a feature of a signal serving as an input of a machine learning model and a probability of a false signal or a true signal serving as teacher data (teacher signal). Therefore, it is conceivable that calculating a probability of a false signal or a true signal on the basis of a time required for the user to make a determination, which is considered to be related to a change in feature of a signal, is a reasonable strategy. In other words, the probability of a false signal or a true signal changes with time, and it is reasonable to set the probability to a larger value as a time required for the user to determine a false signal or a true signal is longer. The probability calculating unit 106 calculates the probability of a false signal or the probability of a true signal on the basis of such an idea. Note that a calculation example by the probability calculating unit 106 will be described later.

The input unit 107 is constituted by, for example, a mouse, a keyboard, or a dedicated interface. The input unit 107 is used when the user inputs that the signal is a false signal or a true signal and performs an operation such as enlargement and reduction of the signal.

The PPI display device 108 is a device that displays a signal acquired by the signal acquiring unit 101 as a signal whose display state changes in time series.

Note that, in the above description, an example in which the storage unit 105, the input unit 107, and the PPI display device 108 are included in the annotation device 100 has been described. However, the storage unit 105, the input unit 107, and the PPI display device 108 are not essential components, and may be disposed outside the annotation device 100, for example.

### (Learning Device 10)

As illustrated in FIG. 1, the learning device 10 includes the annotation device 100 and a learner 110.

The learner 110 generates a machine learning model by performing learning using signal data acquired by the signal acquiring unit 101 and stored in the storage unit 105, and a probability of a false signal or a probability of a true signal calculated by the probability calculating unit 106 as teacher data. This machine learning model is a model that receives, as an input, signal data acquired by the signal acquiring unit 101 and outputs a probability that a signal indicated by the input data is a false signal or a probability that the signal indicated by the input data is a true signal as a continuous value changing depending on a content of an operation specified with an operation log stored in the storage unit 105.

Note that the signal data serving as an input to the machine learning model may be time-series waveform data obtained from a signal acquired by the sensor, or may be the feature amount extracted from the signal. Alternatively, a numerical value obtained by signal processing on the signal may be used as an input.

Note that, in the first embodiment, the probability calculating unit 106 calculates either a probability of a false signal or a probability of a true signal. That is, for example, when calculating the probability of a false signal, the probability calculating unit 106 does not calculate the probability of a true signal. In this case, the learner 110 performs machine learning using the signal data and the probability of a false signal as teacher data.

In this regard, in normal supervised learning, both an annotation result for a true signal and an annotation result for a false signal are required. Meanwhile, in the first embodiment, the learner 110 learns the probability of a false signal or the probability of a true signal by using either one of the probabilities calculated as a continuous value by the probability calculating unit 106 as teacher data.

As described above, an abnormality detection method such as one class support vector machine (SVM) is known as an example of a method in which a learning device performs learning using only one of annotation results for a true signal and a false signal and identifies whether a signal to be identified is true or false. However, in this method, for example, a learning device performs learning using discrete information indicating whether or not a certain signal is a false signal, and cannot perform learning using a continuous value (continuous numerical data) such as a probability of a false signal of a certain signal.

In this regard, the learner 110 in the first embodiment performs learning using a probability of a false signal or a probability of a true signal calculated as a continuous value (continuous numerical data) as teacher data. In addition, as a result of this learning, the learner 110 generates a machine learning model that outputs a probability of a false signal of a certain signal or a probability of a true signal of the signal, the probability being a continuous value, with respect to an input of the signal. The generation of such a machine learning model can be implemented, for example, by the learner 110 performing learning, using a neural network, as a regression task in which a probability of a false signal or a probability of a true signal is used as teacher data.

In addition to the above method, the learner 110 can generate a machine learning model as described above using, for example, a recurrent neural network (RNN) such as a long short term memory (LSTM) or a gated recurrent unit (GRU), which is one of neural networks.

Note that the above-described methods are merely examples, and the learner 110 may generate a machine learning model as described above using a method other than the above-described methods. For example, the learner 110 may generate a machine learning model as described above by performing machine learning using signal data and some continuous value (continuous numerical data) based on a probability of a false signal or a probability of a true signal as teacher data.

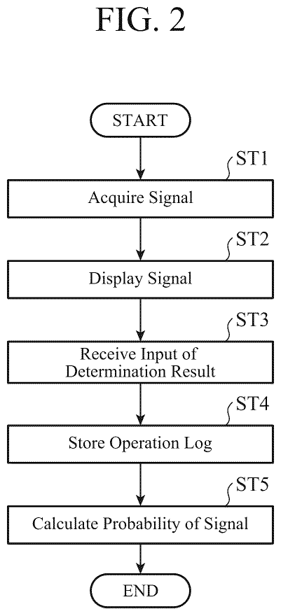

Next, an operation example of the annotation device 100 according to the first embodiment will be described with reference to the flowchart illustrated in FIG. 2. Note that the annotation device 100 periodically repeats the operation according to the flowchart illustrated in FIG. 2.

In addition, here, a case where a user determines whether or not each signal displayed on the PPI display device 108 is a false signal, and inputs that the signal is a false signal using the input unit 107 to the signal determined to be a false signal will be described as an example. Note that the following flowchart is also applicable to a case where a user determines whether or not each signal displayed on the PPI display device 108 is a true signal, and inputs that the signal is a true signal using the input unit 107 to the signal determined to be a true signal.

First, the signal acquiring unit 101 acquires a signal output from the sensor (step ST1).

Next, the display control unit 102 displays the signal acquired by the signal acquiring unit 101 on the PPI display device 108 as a signal whose display state changes in time series (step ST2). A user determines whether or not each signal displayed on the PPI display device 108 is a false signal, and inputs that the signal is a false signal using the input unit 107 to the signal determined to be a false signal.

Next, the input receiving unit 103 receives an operation performed by the user on the signal displayed on the PPI display device 108 and including an input indicating that the signal is a false signal (step ST3).

Next, the storage control unit 104 stores signal data indicating the signal acquired by the signal acquiring unit 101 and an operation log by the user in the storage unit 105 (step ST4).

Next, the probability calculating unit 106 calculates a probability that a signal for which an input indicating a false signal is received by the input receiving unit 103 is a false signal as a continuous value changing depending on a content of an operation specified with the operation log stored in the storage unit 105 (step ST5).

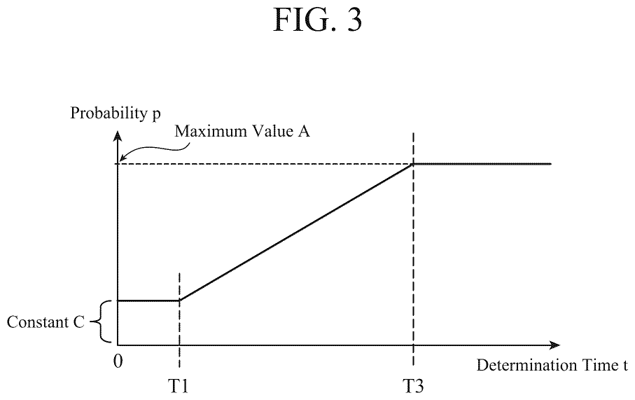

Next, an example of calculating the probability of a false signal in the step ST5 will be described with reference to FIG. 3. FIG. 3 is a diagram for describing a calculation example of the probability of a false signal by the probability calculating unit 106.

In FIG. 3, the horizontal axis represents a time (hereinafter, also referred to as “determination time”) t when the user determines that the signal is a false signal and an input of the determination result is received, and the vertical axis represents a probability p of a false signal calculated by the probability calculating unit 106. Note that the determination time t is specified with the operation log stored in the storage unit 105.

Here, for convenience of description, it is assumed that the probability p of a false signal is a continuous value having a range of 0 to 1, and a maximum value (here, 1) thereof is represented by A.

In addition, in FIG. 3, a time when a signal is acquired by the signal acquiring unit 101 is defined as 0, and a time when the signal is displayed on the PPI display device 108 by the display control unit 102 is defined as T1. In addition, a time T3 represents a time when the probability p of a false signal is the maximum value A.

As illustrated in FIG. 3, the probability p of a false signal is a function related to the determination time t. Note that, as illustrated in FIG. 3, the probability calculating unit 106 calculates the probability p of a false signal as a constant C regardless of the determination time t from the time 0 to the time T1, that is, from when a signal is acquired by the signal acquiring unit 101 to when the signal is displayed on the PPI display device 108. The constant C is a small value such as 0.1, and is set to any value by the user.

Meanwhile, the probability calculating unit 106 linearly increases the probability p of a false signal when the determination time t is between the time T1 and the time T3, and calculates the probability p of a false signal as the maximum value A (here, 1) when the determination time t is the time T3 or after the time T3.

That is, the probability calculating unit 106 increases the probability p of a false signal as the determination time t is farther from the time T1, in other words, as a difference between the determination time t and the time T1 increases. That is, the probability calculating unit 106 calculates the probability p of a false signal as in the following equation (1).

$$p = \{ \begin{matrix}C if t < {T}_{1} \\ C + \frac{( A - C )}{{T}_{3}} ( t - {T}_{1} ) if t \geq {T}_{1} and t < {T}_{3} \\ 1. otherwise\end{matrix} \qquad ( 1 )$$

Note that, here, an example in which the maximum value A of the probability p of a false signal is 1 has been described. However, the probability calculating unit 106 may set the maximum value A of the probability p of a false signal to a value other than 1 in a range of 0 or more and 1 or less. For example, the probability calculating unit 106 may set the maximum value A of the probability p of a false signal to 0.95 or the like.

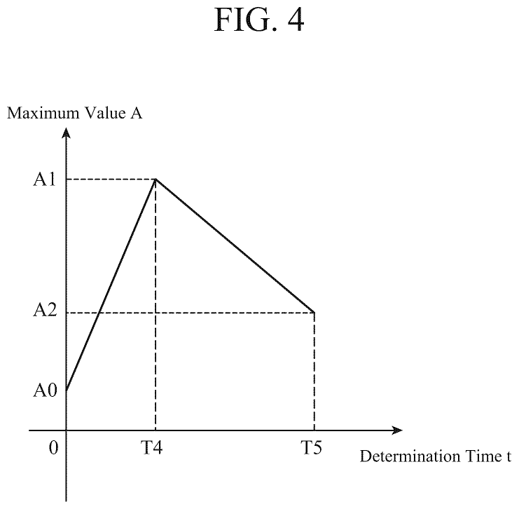

In addition, the probability calculating unit 106 may express the maximum value A of the probability p of a false signal as a function related to the determination time t. An example of this case is illustrated in FIG. 4.

FIG. 4 illustrates an example in which the probability calculating unit 106 changes the maximum value A of the probability p of a false signal with respect to the determination time t. In FIG. 4, the horizontal axis represents the determination time t, and the vertical axis represents the maximum value A of the probability p of a false signal. In the example illustrated in FIG. 4, the maximum value A of the probability p of a false signal is a function related to the determination time t.

For example, in the example illustrated in FIG. 4, in a case where the determination time t is a time T4, the maximum value A of the probability p of a false signal is A1. Meanwhile, in the example illustrated in FIG. 4, when the determination time t is before the time T4, the maximum value A of the probability p of a false signal is a value smaller than A1. This is obtained by setting the maximum value of the probability p of a false signal to be smaller than A1 on the assumption that there is an error in determination of the user because the user inputs a determination result that the signal is a false signal without taking much time.

In addition, in the example illustrated in FIG. 4, also when the determination time t is after the time T4, the maximum value A of the probability p of a false signal is a value (for example, A2) smaller than A1. In the example illustrated in FIG. 4, as the determination time t is delayed from the time T4, the maximum value of the probability p of a false signal is decreased from A1, and when the determination time t is a time T5, the maximum value of the probability p of a false signal is A2. This is obtained by setting the maximum value of the probability p of a false signal to be smaller than A1 on the assumption that it is difficult for the user to make a determination in a case where a certain amount of time is required for the user to make the determination, and that there is an error in the user's determination in this case.

In the case of the example illustrated in FIG. 4, the probability calculating unit 106 calculates the maximum value A of the probability p of a false signal, for example, as in the following equation (2).

$$A = \{ \begin{matrix}{A}_{0} + \frac{( {A}_{1} - {A}_{0} )}{{T}_{4}} {T}_{3} if t < {T}_{4} \\ {A}_{1} - \frac{( {A}_{1} - {A}_{2} )}{{T}_{5} - {T}_{4}} ( {T}_{3} - {T}_{4} ) otherwise\end{matrix} \qquad ( 2 )$$

Note that the functions illustrated in FIGS. 3 and 4 are examples, and the probability calculating unit 106 may calculate the probability p of a false signal and the maximum value A of the probability p of a false signal by a function other than the above functions. For example, the probability calculating unit 106 may calculate the probability p of a false signal on the basis of a function in which the probability p of a false signal monotonically increases with lapse of time from the time TO.

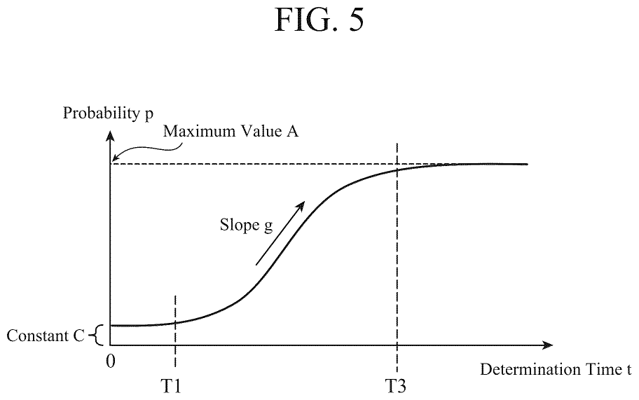

FIG. 5 is a diagram illustrating another calculation example of the probability of a false signal by the probability calculating unit 106. In FIG. 5, the horizontal axis represents the determination time t, and the vertical axis represents the probability p of a false signal. Also in the example illustrated in FIG. 5, similarly to the example illustrated in FIG. 3, the probability p of a false signal is a function related to the determination time t.

In the example illustrated in FIG. 5, the probability p of a false signal increases with lapse of time from the time 0 similarly to that in FIG. 3, but the probability p of a false signal more gradually increases than that in the example of FIG. 3. In FIG. 5, g represents an increase rate (slope) of the probability p of a false signal.

In addition, as illustrated in FIG. 5, as in the example in FIG. 3, the probability calculating unit 106 calculates the probability p of a false signal as a constant C regardless of the determination time t from the time 0 to the time T1, that is, from when a signal is acquired by the signal acquiring unit 101 to when the signal is displayed on the PPI display device 108.

In the case of the example illustrated in FIG. 5, the probability calculating unit 106 calculates the probability p of a false signal, for example, as in the following equation (3), and calculates the constant C, for example, as in the equation (4).

$$p = \frac{A}{1 + {e}^{- g ( t - U )}} \qquad ( 3 )$$

$$C = \frac{A}{1 + {e}^{gU}} \qquad ( 4 )$$

Note that a constant U in equation (3) is a parameter for adjusting a start point at which the probability p of a false signal in FIG. 5 starts to increase and the constant C illustrated in equation (4). In addition, the maximum value A of the probability p of a false signal may be set on the basis of a function similar to, for example, the function described with reference to FIG. 4.

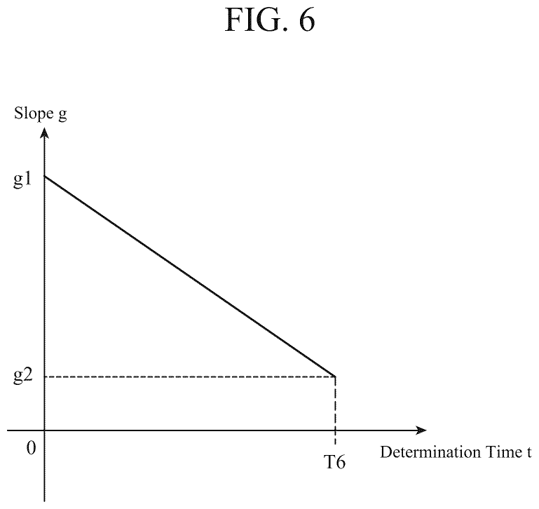

In addition, in the example illustrated in FIG. 5, unlike the example illustrated in FIG. 3, the probability calculating unit 106 can separately set the slope g of the probability p of a false signal. For example, as illustrated in FIG. 6, the probability calculating unit 106 can set the slope g on the basis of a function that sets the slope g depending on the determination time t. In FIG. 6, the horizontal axis represents the determination time t, and the vertical axis represents the slope g of the probability p of a false signal. That is, in the example illustrated in FIG. 6, the slope g of the probability p of a false signal is a function related to the determination time t.

In the example illustrated in FIG. 6, the slope g is increased (for example, g1) in such a manner that the probability p of a false signal quickly reaches the maximum value A as the determination time t is closer to the time 0, that is, as determination of the user is faster, and the slope g is decreased (for example, g2) in such a manner that the probability p of a false signal gradually increases as the determination time t is farther from the time 0, that is, as the determination of the user is slower. Note that, in FIG. 6, the slope is g1 at the time 0, and the slope is g2 at a time T6. In this case, the slope g of the probability p of a false signal is expressed by, for example, the following equation (5). In equation (5), the determination time t is represented by T3. Note that, in a case where the maximum value A of the probability p of a false signal is set by a function related to the determination time t as illustrated in FIG. 4, a value of the maximum value A also changes depending on the determination time t=T6.

$$g = {g}_{1} - \frac{( {g}_{1} - {g}_{2} )}{{T}_{6}} {T}_{3} \qquad ( 5 )$$

In this manner, by expressing the slope g of the probability p of a false signal by a function related to the determination time t, the user can appropriately adjust the degree of relationship (degree of relevance) between the determination time t and the probability p of a false signal.

Note that the functions illustrated in FIGS. 5 and 6 are examples, and the probability p of a false signal and the slope g may be set on the basis of a function other than the above functions. In addition, the slope g of the probability p of a false signal may be a constant value instead of a function related to the determination time t. In addition, the slope g may be set on the basis of a function related to a variable other than the determination time t.

In addition, in FIGS. 3 and 5, an example in which the time when the signal is acquired is defined as 0 and the time when the signal is displayed on the PPI display device 108 is defined as T1 has been described. However, the user may design a function for calculating the probability p of a false signal by defining a time when the signal is displayed on the PPI display device 108 as 0. In this case, an equation indicating the function is an equation obtained by substituting 0 for T1 in the above-described equation (1).

In addition, the method in which the probability calculating unit 106 calculates the probability p of a false signal on the basis of the determination time t specified with the operation log stored in the storage unit 105 has been described so far. However, the probability calculating unit 106 may calculate the probability p of a false signal further using signal data stored in the storage unit 105.

For example, in a case where the signal acquiring unit 101 acquires a plurality of signals and the display control unit 102 displays each of the plurality of signals acquired by the signal acquiring unit 101 on the PPI display device 108 as a signal whose display state changes in time series, the probability calculating unit 106 may correct the above-described determination time t on the basis of at least one of the number of signals displayed on the PPI display device 108 and the density of signals in a predetermined range on the display screen of the PPI display device 108. This is based on an assumption that, in general, it takes more time for a user to determine a false signal as the number of signals displayed on the PPI display device 108 increases, or as the density of signals in a predetermined range on the display screen of the PPI display device 108 increases.

For example, the probability calculating unit 106 may correct the above-described determination time t on the basis of at least one of the number of signals displayed on the PPI display device 108 and the density of signals in a predetermined range on the display screen of the PPI display device 108, and use the corrected time t′ as the determination time t in the functions illustrated in FIGS. 3 to 6. Note that, in this case, the probability calculating unit 106 may correct the determination time t in a direction in which the determination time t is delayed, or may correct the determination time t in a direction in which the determination time t is advanced. In addition, the predetermined range for obtaining the density can be set to any range by the user.

In addition, depending on a distance between a certain signal (for example, first signal) displayed on the PPI display device 108 by the display control unit 102 and a signal (for example, second signal) that the user determined to be a false signal in the past among the signals displayed on the PPI display device 108 by the display control unit 102, the probability calculating unit 106 may change the probability p of a false signal of the certain signal (first signal).

This is based on an assumption that, in general, the farther the position of a certain signal (first signal) displayed on the PPI display device 108 on a screen is from the position of a signal (second signal) that the user determined to be a false signal in the past on the screen, the more delayed the user's attention is paid to the certain signal (first signal), and as a result, it takes more time for the user to determine that the certain signal (first signal) is a false signal.

For example, depending on a distance between a certain signal (first signal) displayed on the PPI display device 108 by the display control unit 102 and a signal (second signal) that the user determined to be a false signal in the past among the signals displayed on the PPI display device 108 by the display control unit 102, the probability calculating unit 106 may correct the determination time t for the first signal, and may use the corrected time t′ as the determination time t in the functions illustrated in FIGS. 3 to 6. Note that, also in this case, the probability calculating unit 106 may correct the determination time t in a direction in which the determination time t is delayed, or may correct the determination time t in a direction in which the determination time t is advanced.

In addition, when determination of a false signal for a certain signal is input to the probability calculating unit 106, for example, the probability calculating unit 106 may change the probability p of the false signal depending on whether the signal displayed on the PPI display device 108 is displayed in a superimposed manner or how many signals are displayed in a superimposed manner in a case where the signal is displayed in a superimposed manner. This is based on an assumption that, in general, in a case where a signal displayed on the PPI display device 108 is displayed in a superimposed manner, it takes a lot of time for the user to determine a false signal for a certain signal.

For example, when determination of a false signal for a certain signal is input to the probability calculating unit 106, the probability calculating unit 106 may correct the determination time t for the certain signal depending on whether the signal displayed on the PPI display device 108 is displayed in a superimposed manner or how many signals are displayed in a superimposed manner in a case where the signal is displayed in a superimposed manner, and may use the corrected time t′ as the determination time t in the functions illustrated in FIGS. 3 to 6. Note that, in this case, the probability calculating unit 106 may correct the determination time t in a direction in which the determination time t is delayed, or may correct the determination time t in a direction in which the determination time t is advanced.

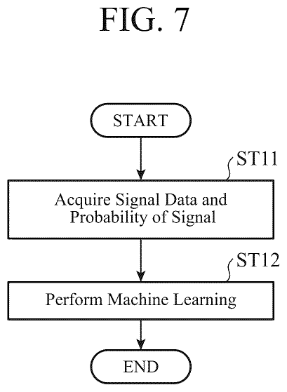

Next, an operation example of the learning device 10 according to the first embodiment will be described with reference to the flowchart illustrated in FIG. 7. Note that the learning device 10 executes the processing according to the flowchart illustrated in FIG. 7 after the operation of the annotation device 100 according to the flowchart illustrated in FIG. 2 is completed.

In addition, here, a case where the probability calculating unit 106 of the annotation device 100 calculates the probability p of a false signal will be described as an example. Note that the following flowchart is also applicable to a case where the probability calculating unit 106 of the annotation device 100 calculates a probability of a true signal.

First, the learner 110 acquires signal data stored in the storage unit 105 and the probability p of a false signal calculated by the probability calculating unit 106 (step ST11).

Next, the learner 110 performs machine learning using the acquired signal data and probability p of a false signal as teacher data (step ST12). As a result, the learner 110 generates a machine learning model that identifies a false signal from a signal indicated by the signal data.

Note that, as described above, the learner 110 generates a machine learning model by a method such as performing learning, using, for example, a neural network, as a regression task in which the probability p of a false signal is used as teacher data.

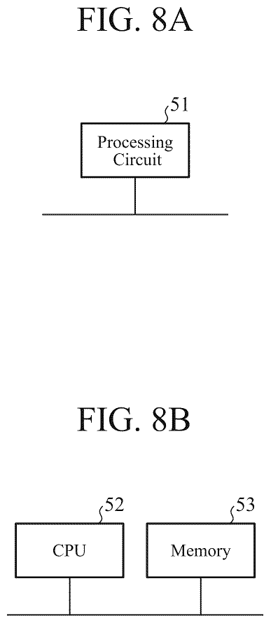

Next, a hardware configuration example of the annotation device 100 according to the first embodiment will be described with reference to FIG. 8.

Functions of the signal acquiring unit 101, the display control unit 102, the input receiving unit 103, the storage control unit 104, and the probability calculating unit 106 in the annotation device 100 are implemented by a processing circuit. The processing circuit may be dedicated hardware as illustrated in FIG. 8A, or a central processing unit (CPU, also referred to as a central processing device, a processing device, a calculation device, a microprocessor, a microcomputer, a processor, or a digital signal processor (DSP)) 52 that executes a program stored in a memory 53 as illustrated in FIG. 8B.

In a case where the processing circuit is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 51. Each of functions of the signal acquiring unit 101, the display control unit 102, the input receiving unit 103, the storage control unit 104, and the probability calculating unit 106 may be implemented by the processing circuit 51, or the functions of the units may be collectively implemented by the processing circuit 51.

When the processing circuit is the CPU 52, the functions of the signal acquiring unit 101, the display control unit 102, the input receiving unit 103, the storage control unit 104, and the probability calculating unit 106 are implemented by software, firmware, or a combination of software and firmware. Software and firmware are each described as a program and stored in the memory 53. By reading and executing the program stored in the memory 53, the processing circuit implements the functions of the units. That is, the annotation device 100 includes the memory for storing a program that causes the steps, for example, illustrated in FIG. 2 to be executed as a result when the program is executed by the processing circuit. It can also be said that these programs cause a computer to execute procedures and methods performed by the signal acquiring unit 101, the display control unit 102, the input receiving unit 103, the storage control unit 104, and the probability calculating unit 106. To the memory 53, for example, a nonvolatile or volatile semiconductor memory such as a random access memory (RAM), a read only memory (ROM), a flash memory, an erasable programmable ROM (EPROM), or an electrically-EPROM (EEPROM), a magnetic disk, a flexible disk, an optical disc, a compact disc, a mini disc, a digital versatile disc (DVD), or the like corresponds.

Note that some of the functions of the signal acquiring unit 101, the display control unit 102, the input receiving unit 103, the storage control unit 104, and the probability calculating unit 106 may be implemented by dedicated hardware, and some of the functions may be implemented by software or firmware. For example, the function of the signal acquiring unit 101 can be implemented by the processing circuit as dedicated hardware, and the functions of the display control unit 102, the input receiving unit 103, the storage control unit 104, and the probability calculating unit 106 can be implemented by the processing circuit reading and executing a program stored in the memory 53.

In this way, the processing circuitry can implement the above-described functions by hardware, software, firmware, or a combination thereof.

As described above, according to the first embodiment, the annotation device 100 includes: the signal acquiring unit 101 that acquires a signal indicating a detection result for a mobile object moving with lapse of time from a sensor that detects the mobile object; the display control unit 102 that displays the signal acquired by the signal acquiring unit 101 on the PPI display device 108 as a signal whose display state changes in time series; the input receiving unit 103 that receives an operation performed by a user on the signal displayed on the PPI display device 108 and including an input indicating that the signal is a false signal or an input indicating that the signal is a true signal; the storage control unit 104 that stores the operation received by the input receiving unit 103 in the storage unit 105 as an operation log; and the probability calculating unit 106 that calculates a probability that a signal for which the input indicating a false signal is received by the input receiving unit 103 is a false signal or a probability that a signal for which the input indicating a true signal is received by the input receiving unit 103 is a true signal as a continuous value changing depending on a content of an operation specified with the operation log stored in the storage unit 105. As a result, the annotation device 100 can perform annotation for generating a machine learning model capable of accurately identifying a false signal or a true signal from a signal whose display state changes in time series and which is displayed on the PPI display device 108.

In addition, the probability calculating unit 106 specifies, with the operation log, a time when the display control unit 102 displays the signal on the PPI display device 108 and a time when the input receiving unit 103 receives an input indicating that the signal is a false signal or an input indicating that the signal is a true signal, and calculates a probability that the signal for which the input indicating a false signal is received by the input receiving unit 103 is a false signal or a probability that the signal for which the input indicating a true signal is received by the input receiving unit 103 is a true signal as a continuous value changing depending on a time from the time when the signal is displayed on the PPI display device 108 to the time when the input receiving unit 103 receives the input indicating that the signal is a false signal or the input indicating that the signal is a true signal. As a result, the annotation device 100 can calculate the probability that the signal is a false signal or the probability that the signal is a true signal as a function of a time from a display time of the signal to an input reception time.

In addition, the signal acquiring unit 101 acquires a plurality of signals, the display control unit 102 displays each of the plurality of signals acquired by the signal acquiring unit 101 on the PPI display device 108 as a signal whose display state changes in time series, and the probability calculating unit 106 corrects a time when an input indicating that the signal is a false signal or an input indicating that the signal is a true signal is received by the input receiving unit 103 on the basis of at least one of the number of signals displayed on the PPI display device 108 by the display control unit 102 and the density of signals in a predetermined range on the display screen of the PPI display device 108, and calculates a probability that the signal for which the input indicating a false signal is received by the input receiving unit 103 is a false signal or a probability that the signal for which the input indicating a true signal is received by the input receiving unit 103 is a true signal as a continuous value changing depending on a time from the time when the signal is displayed on the PPI display device 108 to the corrected time. As a result, the annotation device 100 can suppress difficulty of determination based on the number of signals and the density displayed on the PPI display device 108 from affecting the probability that the signal is a false signal or the probability that the signal is a true signal.

In addition, the signal acquiring unit 101 acquires a plurality of signals, the display control unit 102 displays each of the plurality of signals acquired by the signal acquiring unit 101 on the PPI display device 108 as a signal whose display state changes in time series, the input receiving unit 103 receives an operation performed by the user on a first signal among the plurality of signals displayed on the PPI display device 108 and including an input indicating that the first signal is a false signal or an input indicating that the first signal is a true signal, and the probability calculating unit 106 corrects a time when the input indicating that the first signal is a false signal or the input indicating that the first signal is a true signal is received by the input receiving unit 103 on the basis of a distance between the first signal for which the input indicating a false signal is received by the input receiving unit 103 and the second signal for which the input indicating a false signal was received in the past by the input receiving unit 103, or a distance between the first signal for which the input indicating a true signal is received by the input receiving unit 103 and the second signal for which the input indicating a true signal was received in the past by the input receiving unit 103, and calculates a probability that the first signal for which the input indicating a false signal is received by the input receiving unit 103 is a false signal or a probability that the first signal for which the input indicating a true signal is received by the input receiving unit 103 is a true signal as a continuous value changing depending on a time from the time when the first signal is displayed on the PPI display device 108 to the corrected time. As a result, the annotation device 100 can suppress delay in determination on the first signal based on the distance between the first signal and the second signal displayed on the PPI display device 108 from affecting the probability that the signal is a false signal or the probability that the signal is a true signal.

In addition, the signal acquiring unit 101 acquires a plurality of signals, the display control unit 102 displays each of the plurality of signals acquired by the signal acquiring unit 101 on the PPI display device 108 as a signal whose display state changes in time series, and the probability calculating unit 106 corrects a time when an input indicating that the signal is a false signal or an input indicating that the signal is a true signal is received by the input receiving unit 103 on the basis of at least one of whether the signal displayed on the PPI display device 108 by the display control unit 102 is displayed in a superimposed manner and how many signals are displayed in a superimposed manner in a case where the signal is displayed in a superimposed manner, and calculates a probability that the signal for which the input indicating a false signal is received by the input receiving unit 103 is a false signal or a probability that the signal for which the input indicating a true signal is received by the input receiving unit 103 is a true signal as a continuous value changing depending on a time from the time when the signal is displayed on the PPI display device 108 to the corrected time. As a result, the annotation device 100 can suppress the influence of the difficulty of determination in a case where the signal displayed on the PPI display device 108 is displayed in a superimposed manner from affecting the probability that the signal is a false signal or the probability that the signal is a true signal.

In addition, according to the first embodiment, the learning device 10 includes the annotation device 100 described in claim 1 and the learner 110, and the learner 110 generates a machine learning model that receives, as an input, data indicating a signal acquired by the signal acquiring unit 101 and outputs a probability that a signal indicated by the input data is a false signal or a probability that the signal indicated by the input data is a true signal as a continuous value changing depending on a content of an operation specified with the operation log stored in the storage unit 105 on the basis of data indicating a signal acquired by the signal acquiring unit 101 and a probability that the signal for which the input indicating a false signal is received by the input receiving unit 103 is a false signal or a probability that the signal for which the input indicating a true signal is received by the input receiving unit 103 is a true signal, calculated by the probability calculating unit 106. As a result, the learning device 10 can generate a machine learning model capable of accurately identifying a false signal or a true signal from among signals indicated by signal data acquired by the sensor.

In addition, according to the first embodiment, the annotation device 100 and the learning device 10 have the following effects in addition to the above effects.

### (Effect 1)

It is necessary to prepare a large amount of teacher data (training data), and there is a problem that a large labor cost and time cost are required in annotation work for the teacher data. According to the first embodiment, since the annotation device 100 can create teacher data that needs to be prepared in a large amount from an operation log and signal data during operation, the labor cost and time cost can be reduced.

### (Effect 2)

In a radar system in which a user determines an unnecessary false signal, inputs the determination result, and deletes the false signal from a display in the PPI display device 108 that displays a signal indicating an object such as a ship captured by a radar, there is a problem that cost related to personnel who determines the false signal is required. According to the first embodiment, since the learning device 10 can generate a machine learning model that identifies a false signal, by applying this model at the time of operation, cost related to the personnel who determines the false signal can be reduced.

### (Effect 3)

The learning device 10 generates a machine learning model that identifies a false signal, and the user applies the machine learning model at the time of operation in the radar system, whereby cost of hardware resources required depending on the number of signals simultaneously displayed on the PPI display device 108 can also be reduced.

Specifically, in the radar system, a signal acquired by the sensor is often converted into a signal suitable for a purpose of the user after being subjected to signal processing such as tracking processing and suppression of unnecessary signal components before being displayed. In such a case, when the number of signals simultaneously displayed on the PPI display device 108 increases, in the radar system, there is a problem that a sensor and hardware resources required for signal processing also increase in size.

In this regard, according to the first embodiment, since the output of the machine learning model generated by the learning device 10 is a continuous value of a probability of a false signal, the user can give priority to each signal to be deleted from a screen depending on a numerical value of the continuous value. For example, in a case where there is a possibility that the number of signals simultaneously displayed exceeds an upper limit value based on the hardware resources, the user can eliminate a display defect due to shortage of the hardware resources by preferentially deleting a signal having a larger probability of a false signal.

### (Effect 4)

In a case where teacher data is created using an operation log by the user during operation of the radar system as an annotation result indicating whether a signal is true or false, the user does not necessarily determine all the displayed false signals and input the determination results, and there is a problem that a signal that is not determined to be the false signal is not necessarily a true signal. This is because the signal displayed over time may disappear before the user inputs the determination result, and a determination result of a signal for which it is difficult to determine whether or not the signal is a false signal is not input by the user in some cases. That is, in this case, a verified true signal cannot be obtained.

Under such a background, in conventional supervised learning, a learning device requires training data including signal data of both true and false and an annotation result thereof (teacher data indicating true or false) for the signal data in a well-balanced manner. Therefore, even when the conventional learning device learns signal data and an annotation result of only one of true and false or biased to either one of true and false, identification accuracy of a generated machine learning model may be significantly deteriorated.

In this regard, according to the first embodiment, the learning device 10 performs learning using a probability of a false signal corresponding to only a signal determined to be a false signal or a probability of a true signal corresponding to only a signal determined to be a true signal, and therefore improvement in identification accuracy of a generated machine learning model can be expected.

### (Effect 5)

A true value of whether or not the signal displayed on the PPI display device 108 during operation of the radar system is a false signal is unknown, and a determination result of the user is not always correct. When supervised learning is performed using a binary label indicating whether a signal is false or not, in a case where a determination result of the user is wrong, identification accuracy of a machine learning model obtained by learning by the learning device may be significantly deteriorated. In this regard, according to the first embodiment, the learning device 10 learns a probability of a false signal or a true signal that is a continuous numerical value, obtained by the annotation device 100 instead of the binary label indicating whether or not a signal is false. As a result, even when a determination result of the user is wrong, the learning device 10 obtains a small value as the probability of a false signal or a true signal of the signal included in the teacher data, and therefore improvement in identification accuracy of a generated machine learning model can be expected.

### (Effect 6)

During operation of the radar system, whether or not the signal displayed on the PPI display device 108 is an unnecessary false signal depends on an individual difference between users, an operation purpose of the system, and the like. Therefore, even when the learning device performs learnings using teacher data acquired in advance before operation of the system and generates a machine learning model, a false signal at the time of system operation may be different from a false signal in the teacher data acquired in advance. In this case, the generated machine learning model cannot output an identification result suitable for the individual difference between users, the operation purpose of the system, and the like, and identification accuracy from a viewpoint of the user may be low. In this regard, according to the first embodiment, since the annotation device 100 can generate an annotation result from an operation log by the user at the time of system operation, improvement in identification accuracy of a machine learning model generated by the learning device 10 that performs learning on the basis of the annotation result can be expected.

### Second Embodiment

In the first embodiment, the annotation device that calculates a probability of a false signal or a probability of a true signal as a continuous value changing depending on a content of an operation specified with an operation log has been described. In a second embodiment, an annotation device that can display related information of any signal selected by a user from among signals displayed on a PPI display device 108 will be described.

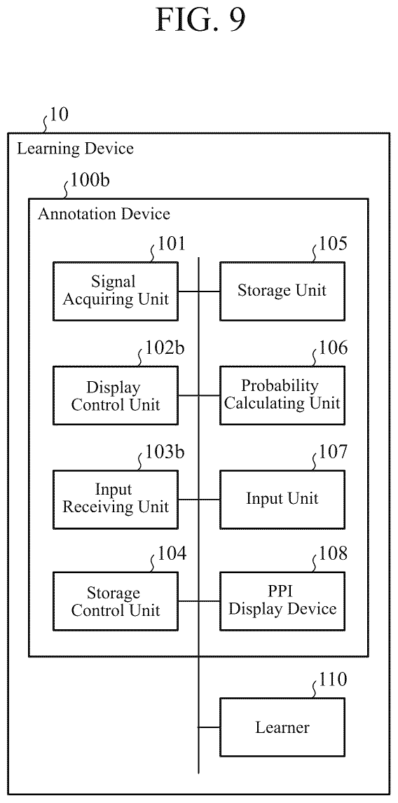

FIG. 9 is a configuration diagram illustrating a learning device 10 including an annotation device 100b according to the second embodiment.

In the annotation device 100b according to the second embodiment illustrated in FIG. 9, the display control unit 102 is replaced with a display control unit 102b, and the input receiving unit 103 is replaced with an input receiving unit 103b as compared with the annotation device 100 according to the first embodiment illustrated in FIG. 1. Since the other components of the annotation device 100b according to the second embodiment illustrated in FIG. 8 are similar to those of the annotation device 100 according to the first embodiment illustrated in FIG. 1, the same reference numerals are given, and description thereof is omitted.

The display control unit 102b displays a signal acquired by a signal acquiring unit 101 on the PPI display device 108 as a signal whose display state changes in time series.

The input receiving unit 103b receives a user's selection operation on the signal displayed on the PPI display device 108 by the display control unit 102b. For example, the user selects, using an input unit 107, a signal for which it is desired to confirm information related to a signal (hereinafter, also referred to as “related information”) from among the signals displayed on the PPI display device 108 by the display control unit 102b. The input receiving unit 103b receives the selection operation performed by the user.

The related information is, for example, information related to a feature amount (for example, coordinates, a moving speed, and a signal strength) of the signal extracted from the signals by a signal acquiring unit 101 and stored in the storage unit 105. In this case, the feature amount of the signal may include a feature amount of the signal in the past. The related information is a material for the user to determine whether the signal is a false signal or a true signal.

When a signal selection operation is received by the input receiving unit 103b, the display control unit 102b extracts information (related information) related to the signal for which the selection operation is received from the storage unit 105, and displays the extracted related information on the PPI display device 108. The user determines whether the signal is a false signal or a true signal while confirming the related information, and inputs the determination result to a signal determined to be the false signal or a signal determined to be the true signal.

The input receiving unit 103b receives an input indicating that each signal displayed on the PPI display device 108 by the display control unit 102b is a false signal or an input indicating that the signal is a true signal, performed by the user.

Signal data including the related information may include a very large amount of information. Therefore, when the display control unit 102b displays the information on the PPI display device 108 for all the signals, the amount of information displayed on the PPI display device 108 increases, which may be troublesome for the user. Therefore, in the second embodiment, the display control unit 102b displays the related information on the PPI display device 108 only for a signal selected by the user. This reduces user's troublesomeness.

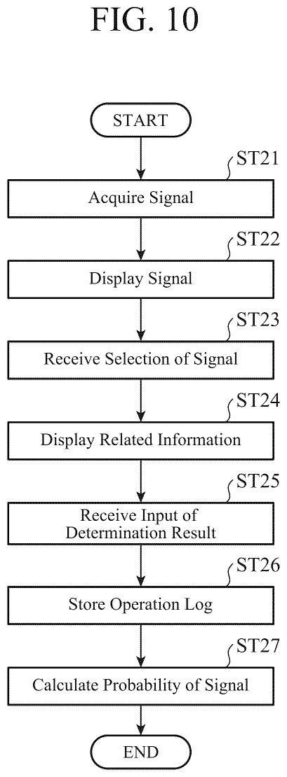

Next, an operation example of the annotation device 100b according to the second embodiment will be described with reference to the flowchart illustrated in FIG. 10. Note that the annotation device 100b repeats the operation according to the flowchart illustrated in FIG. 10.

First, the signal acquiring unit 101 acquires one or more signals received by a sensor from the sensor (step ST21).

Next, the display control unit 102b displays the signal acquired by the signal acquiring unit 101 on the PPI display device 108 as a signal whose display state changes in time series (step ST22).

Next, the input receiving unit 103b receives a user's selection operation on the signal displayed on the PPI display device 108 by the display control unit 102b (step ST23).

Next, when the signal selection operation is received by the input receiving unit 103b, the display control unit 102b displays information (related information) related to the signal for which the selection operation is received on the PPI display device 108 (step ST24).

Hereinafter, steps ST25 to ST27 are similar to steps ST3 to ST5 in FIG. 2 described in the first embodiment, and thus, repeated description thereof is omitted.

Note that, in step ST27, a probability calculating unit 106 may calculate a probability p of a false signal in consideration of a time when the input receiving unit 103b receives the selection operation from the user in step ST13.

For example, in the function of FIG. 3 described in the first embodiment, the probability calculating unit 106 may calculate a probability by adding a time (hereinafter, also referred to as “selection time”) T2 when the input receiving unit 103b receives the selection operation from the user to a determination time t on the horizontal axis in the functions of FIGS. 3 and 5 described in the first embodiment. For example, the probability calculating unit 106 may calculate the probability p of a false signal depending on a difference between the selection time T2 and the determination time t in the functions of FIGS. 3 and 5. In this case, for example, the probability calculating unit 106 may calculate the probability p of a false signal to be larger as the difference between the selection time T2 and the determination time t is larger. In addition, in this case, the probability calculating unit 106 may calculate the probability p of a false signal by regarding, for example, the selection time T2 and the time T1 as the same time.

In addition, the probability calculating unit 106 may change a maximum value A of the probability p of a false signal with respect to the selection time T2 similarly to the function of FIG. 4 described in the first embodiment. In addition, the probability calculating unit 106 may change a slope g of the probability p of a false signal with respect to the time T2 similarly to the function of FIG. 6 described in the first embodiment.

In addition, in the first embodiment, it has been described that the probability calculating unit 106 may correct the above-described determination time t on the basis of at least one of the number of signals displayed on the PPI display device 108 and the density of signals in a predetermined range on the display screen of the PPI display device 108.

The same applies to the selection time T2, and depending on a state of a signal, it may take time for the user to select a signal, and the selection time T2 may be later than an assumed time. Therefore, when the selection time T2 is considered in the functions of FIGS. 3 to 6, the probability calculating unit 106 may also correct the selection time T2 depending on the number of signals and the density, and may use a corrected time T2′ as the selection time T2 in each function.

In addition, in the second embodiment, the selection time T2 may change depending on, for example, the degree of complexity of signal motion in the PPI display device 108 or the degree of difference in signal motion with respect to assumed signal motion in addition to the number of signals and the density as described above. For example, when it is difficult for the user to select a signal because signal motion in the PPI display device 108 is complex (random), it is conceivable that an operation of selecting the signal by the user takes time, and the selection takes time. As a result, the selection time T2 may be later than an assumed time.

Therefore, when considering the selection time T2 in the functions of FIGS. 3 to 6, the probability calculating unit 106 may correct the selection time T2 depending on the degree of complexity of signal motion in the PPI display device 108 or the degree of difference in signal motion with respect to assumed signal motion, and may use the corrected time T2′ as the selection time T2 in each function.

Note that, when the probability calculating unit 106 considers the selection time T2, in a case where a certain signal (for example, a first signal) is selected by the user, then another signal (for example, a second signal) is selected, and then the original signal (first signal) is selected again, the probability calculating unit 106 adopts a time when the first signal is finally selected as the selection time T2 of the first signal.

In addition, when considering the selection time T2, the probability calculating unit 106 may correct the time T2 when a certain signal (for example, a first signal) is selected by the user depending on whether or not another signal (for example, a second signal) is selected before the selection or how many other signals are selected before the selection, and use the corrected time T2′ as the selection time T2 for the certain signal (first signal) in each function.

Note that, in the above description, the selection of a signal by the user has been described as an example of the operation by the user, but the operation by the user is not limited thereto. For example, the operation by the user may be an operation other than signal selection as long as the operation is performed by the user in order to determine a false signal or a true signal, the operation can be performed by using the input unit 107, and a time of the operation can be stored in the storage unit 105.

As described above, according to the second embodiment, the signal acquiring unit 101 acquires a plurality of signals, the storage control unit 104 stores related information related to each of the plurality of signals acquired by the signal acquiring unit 101 in the storage unit 105, the display control unit 102b displays each of the plurality of signals acquired by the signal acquiring unit 101 on the PPI display device 108 as a signal whose display state changes in time series, the input receiving unit 103b receives a selection operation performed by the user on any signal among the plurality of signals displayed on the PPI display device 108, and the display control unit 102b extracts the related information related to the signal whose selection operation is received by the input receiving unit 103b from the storage unit 105 and displays the extracted related information on the PPI display device 108. As a result, the annotation device 100b according to the second embodiment reduces user's troublesomeness because the related information is displayed on the PPI display device 108 only for a signal selected by the user in addition to having the effects of the first embodiment.

In addition, the input receiving unit 103b receives a selection operation performed by the user on the first signal among the plurality of signals displayed on the PPI display device 108 and an operation including an input indicating that the first signal is a false signal or an input indicating that the first signal is a true signal, and the probability calculating unit 106 specifies, with an operation log, a time when the selection operation on the first signal is received by the input receiving unit 103b and a time when the input indicating that the first signal is a false signal or the input indicating that the first signal is a true signal is received by the input receiving unit 103b, and calculates a probability that the first signal is a false signal or a probability that the first signal is a true signal as a continuous value changing depending on a time from the time when the selection operation is received by the input receiving unit 103b to the time when the input indicating that the first signal is a false signal or the input indicating that the first signal is a true signal is received by the input receiving unit 103b. As a result, the annotation device 100b can calculate the probability that the signal is a false signal or the probability that the signal is a true signal as a function of a time from a selection time of the signal to an input reception time.

In addition, the probability calculating unit 106 specifies whether or not the input receiving unit 103b has received a selection operation of a signal other than the first signal after receiving the selection operation of the first signal with the operation log, and has further received the selection operation of the first signal, corrects a time when the selection operation of the first signal was finally received by the input receiving unit 103b in a case where the input receiving unit 103b has received a selection operation of a signal other than the first signal after receiving the selection operation of the first signal, and has further received the selection operation of the first signal, and calculates a probability that the first signal is a false signal or a probability that the first signal is a true signal as a continuous value changing depending on a time from the corrected time to a time when the input indicating that the first signal is a false signal or the input indicating that the first signal is a true signal is received by the input receiving unit 103b. As a result, the annotation device 100b can suppress delay in selection due to selection of another signal in a process until the first signal displayed on the PPI display device 108 is selected from affecting a probability that the signal is a false signal or a probability that the signal is a true signal.

Note that the present disclosure can freely combine the embodiments to each other, modify any constituent element in each of the embodiments, or omit any constituent element in each of the embodiments.

### INDUSTRIAL APPLICABILITY

The present disclosure can perform annotation for generating a machine learning model capable of accurately identifying a false signal or a true signal from a signal displayed on a PPI display device, and is suitable for use in an annotation device and a learning device.

### REFERENCE SIGNS LIST

10: learning device, 51: processing circuit, 52: CPU, 53: memory, 100: annotation device, 100b: annotation device, 101: signal acquiring unit, 102: display control unit, 102b: display control unit, 103: input receiving unit, 103b: input receiving unit, 104: storage control unit, 105: storage unit, 106: probability calculating unit, 107: input unit, 108: PPI display device, 110: learner, A, A0, A1, A2: maximum value, C: constant, g, g1, g2: slope, p: probability, T1, T3, T4, T5, T6: time

1. An annotation device comprising:
a processor; and
a memory storing a program, upon executed by the processor, to perform a process:
to acquire a signal indicating a detection result for a mobile object moving with lapse of time from a sensor to detect the mobile object;
to display the signal acquired on a plan position indicator (PPI) display device as a signal whose display state changes in time series;
to receive an operation performed by a user on the signal displayed on the PPI display device and including an input indicating that the signal is a false signal or an input indicating that the signal is a true signal;
to store the operation received in a storage as an operation log; and
to calculate a probability that a signal for which the input indicating a false signal is received is a false signal or a probability that a signal for which the input indicating a true signal is received is a true signal as a continuous value changing depending on a content of an operation specified with the operation log stored in the storage,
wherein
the process acquires a plurality of the signals,
the process displays each of the plurality of signals acquired on the PPI display device as a signal whose display state changes in time series, and
wherein
the process
specifies, with the operation log, a time when the process displays the signal on the PPI display device and a time when the process receives an input indicating that the signal is a false signal or an input indicating that the signal is a true signal,
calculates a probability that the signal for which the input indicating a false signal is received is a false signal or a probability that the signal for which the input indicating a true signal is received is a true signal as a continuous value changing depending on a time from the time when the signal is displayed on the PPI display device to the time when the process receives the input indicating that the signal is a false signal or the input indicating that the signal is a true signal,
corrects a time when the input indicating that the signal is a false signal or the input indicating that the signal is a true signal is received on a basis of at least one of the number of signals displayed on the PPI display device by the process and a density of the signals in a predetermined range on a display screen of the PPI display device, and
calculates a probability that the signal for which the input indicating a false signal is received is a false signal or a probability that the signal for which the input indicating a true signal is received is a true signal as a continuous value changing depending on a time from a time when the signal is displayed on the PPI display device to the corrected time.

2. An annotation device comprising:
a processor; and
a memory storing a program, upon executed by the processor, to perform a process:
to acquire a signal indicating a detection result for a mobile object moving with lapse of time from a sensor to detect the mobile object;
to display the signal acquired on a plan position indicator (PPI) display device as a signal whose display state changes in time series;
to receive an operation performed by a user on the signal displayed on the PPI display device and including an input indicating that the signal is a false signal or an input indicating that the signal is a true signal;
to store the operation received in a storage as an operation log; and
to calculate a probability that a signal for which the input indicating a false signal is received is a false signal or a probability that a signal for which the input indicating a true signal is received is a true signal as a continuous value changing depending on a content of an operation specified with the operation log stored in the storage,
wherein
the process acquires a plurality of the signals,
the process displays each of the plurality of signals acquired on the PPI display device as a signal whose display state changes in time series,
the process
receives an operation performed by the user on a first signal among the plurality of signals displayed on the PPI display device and including an input indicating that the first signal is a false signal or an input indicating that the first signal is a true signal, and
wherein
the process
specifies, with the operation log, a time when the process displays the signal on the PPI display device and a time when the process receives an input indicating that the signal is a false signal or an input indicating that the signal is a true signal,
calculates a probability that the signal for which the input indicating a false signal is received is a false signal or a probability that the signal for which the input indicating a true signal is received is a true signal as a continuous value changing depending on a time from the time when the signal is displayed on the PPI display device to the time when the process receives the input indicating that the signal is a false signal or the input indicating that the signal is a true signal,
corrects a time when the input indicating that the first signal is a false signal or the input indicating that the first signal is a true signal is received on a basis of a distance between the first signal for which the input indicating a false signal is received and the second signal for which the input indicating a false signal was received in the past, or a distance between the first signal for which the input indicating a true signal is received and the second signal for which the input indicating a true signal was received in the past, and
calculates a probability that the first signal for which the input indicating a false signal is received is a false signal or a probability that the first signal for which the input indicating a true signal is received is a true signal as a continuous value changing depending on a time from a time when the first signal is displayed on the PPI display device to the corrected time.

3. An annotation device comprising:
a processor; and
a memory storing a program, upon executed by the processor, to perform a process:
to acquire a signal indicating a detection result for a mobile object moving with lapse of time from a sensor to detect the mobile object;
to display the signal acquired on a plan position indicator (PPI) display device as a signal whose display state changes in time series;
to receive an operation performed by a user on the signal displayed on the PPI display device and including an input indicating that the signal is a false signal or an input indicating that the signal is a true signal;
to store the operation received in a storage as an operation log; and
to calculate a probability that a signal for which the input indicating a false signal is received is a false signal or a probability that a signal for which the input indicating a true signal is received is a true signal as a continuous value changing depending on a content of an operation specified with the operation log stored in the storage,
wherein
the process acquires a plurality of the signals,
the process displays each of the plurality of signals acquired on the PPI display device as a signal whose display state changes in time series, and
wherein
the process
specifies, with the operation log, a time when the process displays the signal on the PPI display device and a time when the process receives an input indicating that the signal is a false signal or an input indicating that the signal is a true signal,
calculates a probability that the signal for which the input indicating a false signal is received is a false signal or a probability that the signal for which the input indicating a true signal is received is a true signal as a continuous value changing depending on a time from the time when the signal is displayed on the PPI display device to the time when the process receives the input indicating that the signal is a false signal or the input indicating that the signal is a true signal,
corrects a time when the input indicating that the signal is a false signal or the input indicating that the signal is a true signal is received on a basis of at least one of whether the signal displayed on the PPI display device is displayed in a superimposed manner and how many signals are displayed in a superimposed manner in a case where the signal is displayed in a superimposed manner, and
calculates a probability that the signal for which the input indicating a false signal is received is a false signal or a probability that the signal for which the input indicating a true signal is received is a true signal as a continuous value changing depending on a time from a time when the signal is displayed on the PPI display device to the corrected time.

4. The annotation device according to claim 1, wherein
the process acquires a plurality of the signals,
the process stores related information related to each of the plurality of signals acquired in the storage,
the process displays each of the plurality of signals acquired on the PPI display device as a signal whose display state changes in time series,
the process receives a selection operation performed by the user on any signal among the plurality of signals displayed on the PPI display device, and
the process extracts related information related to the signal whose selection operation is received from the storage and displays the extracted related information on the PPI display device.

5. The annotation device according to claim 4, wherein
the process
receives the selection operation performed by the user on the first signal among the plurality of signals displayed on the PPI display device and an operation including an input indicating that the first signal is a false signal or an input indicating that the first signal is a true signal, and
the process
specifies, with the operation log, a time when the selection operation on the first signal is received and a time when the input indicating that the first signal is a false signal or the input indicating that the first signal is a true signal is received, and
calculates a probability that the first signal is a false signal or a probability that the first signal is a true signal as a continuous value changing depending on a time from the time when the selection operation is received to the time when the input indicating that the first signal is a false signal or the input indicating that the first signal is a true signal is received.

6. The annotation device according to claim 5, wherein
the process
specifies whether or not the process has received a selection operation of a signal other than the first signal after receiving the selection operation of the first signal with the operation log, and has further received the selection operation of the first signal,
corrects a time when the selection operation of the first signal was finally received in a case where the process has received a selection operation of a signal other than the first signal after receiving the selection operation of the first signal, and has further received the selection operation of the first signal, and
calculates a probability that the first signal is a false signal or a probability that the first signal is a true signal as a continuous value changing depending on a time from the corrected time to a time when the input indicating that the first signal is a false signal or the input indicating that the first signal is a true signal is received.

7. An annotation method comprising:
acquiring a signal indicating a detection result for a mobile object moving with lapse of time from a sensor to detect the mobile object;
displaying the signal acquired on a plan position indicator (PPI) display device as a signal whose display state changes in time series;
receiving an operation performed by a user on the signal displayed on the PPI display device and including an input indicating that the signal is a false signal or an input indicating that the signal is a true signal;
storing the operation received in a storage as an operation log; and
calculating, a probability that a signal for which the input indicating a false signal is received is a false signal or a probability that a signal for which the input indicating a true signal is received is a true signal as a continuous value changing depending on a content of an operation specified with the operation log stored in the storage,
wherein
the method acquires a plurality of the signals,
the method displays each of the plurality of signals acquired on the PPI display device as a signal whose display state changes in time series, and
wherein
the method
specifies, with the operation log, a time when the method displays the signal on the PPI display device and a time when the method receives an input indicating that the signal is a false signal or an input indicating that the signal is a true signal,
calculates a probability that the signal for which the input indicating a false signal is received is a false signal or a probability that the signal for which the input indicating a true signal is received is a true signal as a continuous value changing depending on a time from the time when the signal is displayed on the PPI display device to the time when the method receives the input indicating that the signal is a false signal or the input indicating that the signal is a true signal,
corrects a time when the input indicating that the signal is a false signal or the input indicating that the signal is a true signal is received on a basis of at least one of the number of signals displayed on the PPI display device and a density of the signals in a predetermined range on a display screen of the PPI display device, and
calculates a probability that the signal for which the input indicating a false signal is received is a false signal or a probability that the signal for which the input indicating a true signal is received is a true signal as a continuous value changing depending on a time from a time when the signal is displayed on the PPI display device to the corrected time.

8. A learning device comprising
the annotation device according to claim 1 and a learner, wherein
the learner
generates a machine learning model to receive, as an input, data indicating the signal acquired and to output a probability that a signal indicated by the input data is a false signal or a probability that the signal indicated by the input data is a true signal as a continuous value changing depending on a content of an operation specified with the operation log stored in the storage
on a basis of
data indicating a signal acquired, and
a probability that the signal for which the input indicating a false signal is received is a false signal or a probability that the signal for which the input indicating a true signal is received is a true signal, calculated.
